(19) United States
(12) Patent Application Publication
(10) Pub. No.: US 2009/0158152 A1
(43) Pub. Date: Jun. 18, 2009

(54) SYSTEM AND METHOD FOR GENERATING CONTEXT SENSITIVE HELP FOR A GRAPHICAL USER INTERFACE

(76) Inventors: Marianne L. Kodimer, Huntington Beach, CA (US); Harpreet Singh, Orange, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/954,365

(22) Filed: Dec. 12, 2007

(51) Int. Cl. G06F 3/00

(52) U.S. Cl. 715/708

(57) ABSTRACT

The subject application is directed to a system and method for generating context sensitive help for a graphical user interface. Display data corresponding to a plurality of indicia is first generated on an associated display, each indicia corresponding to a functionality of an associated information processing device. Selection data is then received corresponding to a selected indicia from those displayed. A touch down signal is then received corresponding to a tactile exertion of positive physical pressure. Duration data representing the duration of the exerted positive physical pressure is then received. A display of data associated with the functionality of the information processing device is subsequently triggered in accordance with the selected indicia corresponding to the received selection data and the received duration data.

### BACKGROUND OF THE INVENTION

The subject application is directed generally to context sensitive user assistance for graphical user interfaces. The application is particularly suited to providing assistance to users of relatively complex interfaces used to control operation of data processing devices, such as document processing devices.

Early device control interfaces often included a plurality of switches, such as push buttons. Individual switches were provided for many functions. As devices became more sophisticated, so did the number of control inputs that were required.

More recently, graphical user interfaces were added to provide more sophisticated control to data processing devices, including devices, such as information kiosks, document processing devices such as copiers, printers, facsimile machines, scanners or multifunction peripherals having two or more of such functions. Graphical user interfaces are advantageous insofar as they provide a flexible, user-friendly, display where software is used to generate ordered, hierarchical controls for the many functions associated with complex devices. Frequently, device control or operation functionality employs one or more selectable display areas, such as a key display or graphical icon associated with such functionality. A user selects the functionality in accordance with the associated display indicia, and thus completes a selected operation. Simpler or more frequently used operations, as well as more uniform display elements such as a printer icon, are well understood by users. However, less frequently used or unique functions are often not understood by users, and require further explanation.

Earlier computer systems employ “help” functions. Such functions can be text based, wherein a user can enter a text string corresponding to a function or interface element, and receive additional information about such function. With the advent of windowing interfaces employing a point device, such as a trackball, mouse, touch pad, or the like, other help systems would give further information relative to an icon's associated function upon sensing of a pointer icon to be proximate thereto.

Unlike a typical graphical user interface for a desktop or portable computer system, a graphical user interface for controlling a system such as a document processing system typically employs an embedded display which is relatively small as compared to a video display of a typical desktop or portable data device. It is difficult to secure relevant, context sensitive help, for such control interfaces.

### SUMMARY OF THE INVENTION

In accordance with one embodiment of the subject application, there is provided a system and method directed to context sensitive user assistance for graphical user interfaces.

Further, in accordance with one embodiment of the subject application, there is provided a system and method for providing assistance to users of relatively complex interfaces used to control operation of data processing devices, such as document processing devices.

Still further, in accordance with one embodiment of the subject application, there is provided a system for generating context sensitive help for a graphical user interface. The system comprises means adapted for generating display data corresponding to a display having a plurality of indicia, wherein each indicia corresponds to at least one functionality of an associated information processing device. The system also comprises means adapted for receiving selection data corresponding to a selected indicia from the plurality thereof and means adapted for receiving a touch down signal corresponding to a tactile exertion of positive physical pressure. The system further comprises means adapted for receiving duration data corresponding to a duration of tactile exertion of positive physical pressure and trigger means adapted for triggering a display of data corresponding to functionality of the associated information processing device corresponding to a selected indicia in accordance with received selection data and received duration data.

In one embodiment of the subject application, the trigger means includes means adapted for triggering the display of data when the duration data exceeds a preselected duration of tactile exertion of positive physical pressure. Preferably, the system also comprises means adapted for generating a user feedback signal corresponding to receipt of a touch down signal.

In another embodiment of the subject application, the system further comprises means adapted for terminating the display of data upon receipt of a touch up signal corresponding to removal of tactile exertion of positive physical pressure. Preferably, the associated information processing device includes means adapted for performing at least one document processing operation in accordance with the selected indicia upon receipt of the touch up signal.

In a further embodiment of the subject application, the system also comprises a touch screen display, the touch screen display including means adapted for generating a visual representation of each of the plurality of indicia. In such embodiment, the means adapted for generating the touch down signal is from a sensed tactile exertion of positive physical pressure on a surface thereof corresponding to the selected indicia.

Still further, in accordance with one embodiment of the subject application, there is provided a method for generating context sensitive help for a graphical user interface in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for generating context sensitive help for a graphical user interface according to one embodiment of the subject application;

FIG. 2 is a block diagram illustrating controller hardware for use in the system for generating context sensitive help for a graphical user interface according to one embodiment of the subject application;

FIG. 3 is a functional diagram illustrating the controller for use in the system for generating context sensitive help for a graphical user interface according to one embodiment of the subject application;

FIG. 4 is a flowchart illustrating a method for generating context sensitive help for a graphical user interface according to one embodiment of the subject application;

FIG. 5 is a flowchart illustrating a method for generating context sensitive help for a graphical user interface according to one embodiment of the subject application;

FIG. 6 is an example template of a user interface for use in the system for generating context sensitive help for a graphical user interface according to one embodiment of the subject application;

FIG. 7 is an example of user interaction with an interface of the system for generating context sensitive help for a graphical user interface according to one embodiment of the subject application;

FIG. 8 is an example of user interaction with an interface of the system for generating context sensitive help for a graphical user interface according to one embodiment of the subject application; and

FIG. 9 is an example of user interaction with an interface of the system for generating context sensitive help for a graphical user interface according to one embodiment of the subject application.

### DETAILED DESCRIPTION OF THE PREFERRED EMBODIMENT

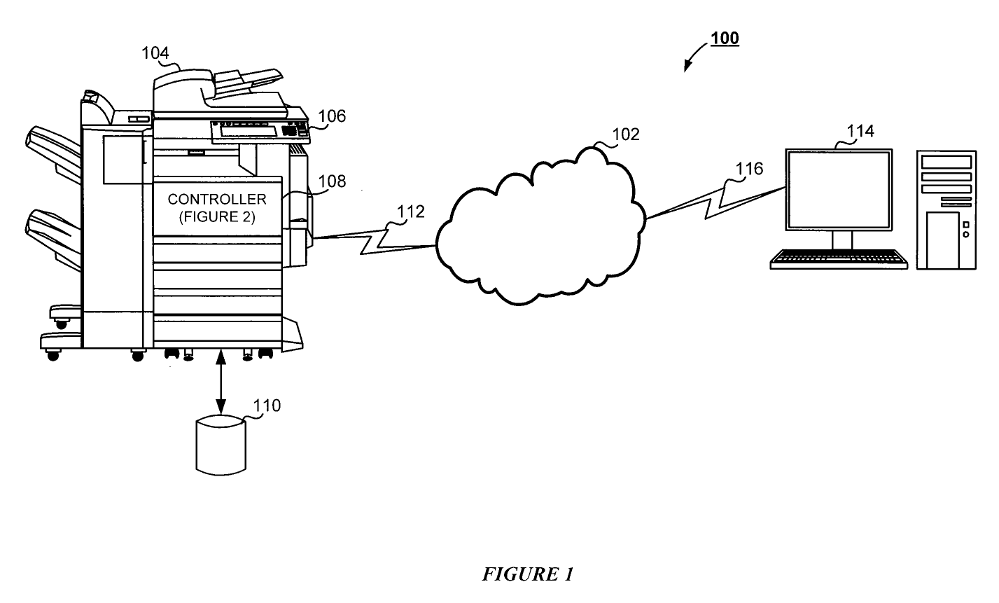

The subject application is directed to a system and method for context sensitive help for a graphical user interface. In particular, the subject application is directed to a system and method for providing assistance to users of relatively complex interfaces used to control operation of data processing devices, such as document processing devices. More particularly, the subject application is directed to a system and method that allows a user to generating context sensitive help for a graphical user interface. It will become apparent to those skilled in the art that the system and method described herein are suitably adapted to a plurality of varying electronic fields employing graphical user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for generating context sensitive help for a graphical user interface in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

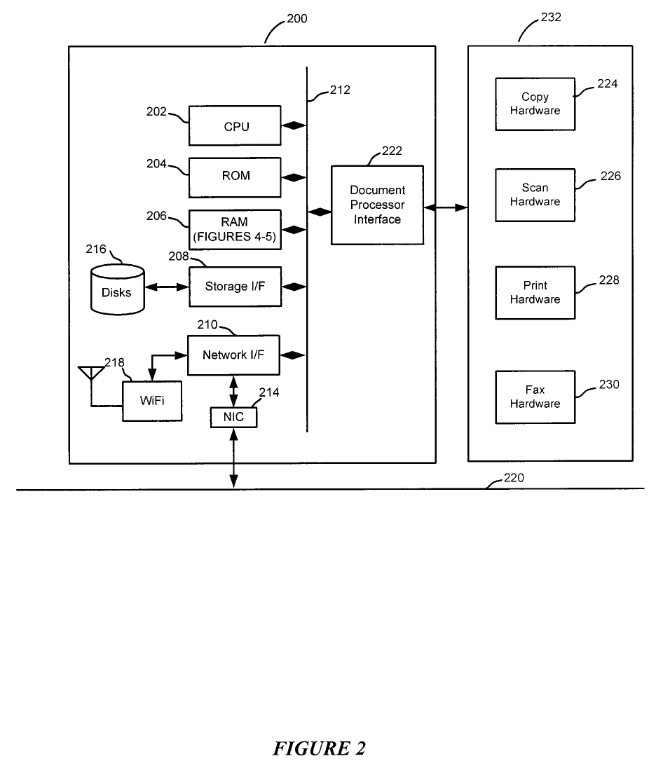

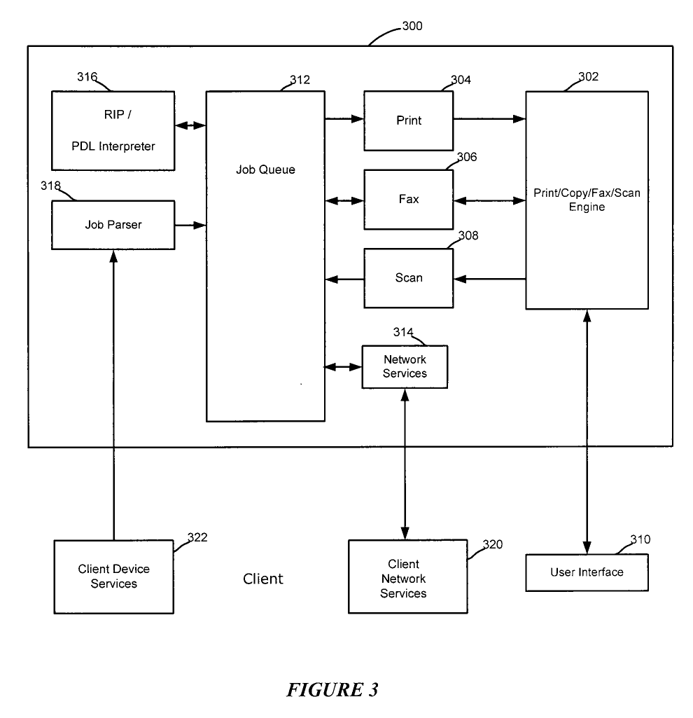

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for generating context sensitive help for a graphical user interface of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 200 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the controller 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter, or any suitable mechanism for interchange of an electronic document to a format better suited for interchange with device functions such as print 304, facsimile 306, or scan 308.

Finally, the job queue 312 is in data communication with a parser 318, which parser 318 suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

In operation, display data corresponding to a plurality of indicia is first generated on an associated display, each indicia corresponding to a functionality of an associated information processing device. Selection data is then received corresponding to a selected indicia from those displayed. A touch down signal is then received corresponding to a tactile exertion of positive physical pressure. Duration data representing the duration of the exerted positive physical pressure is then received. A display of data associated with the functionality of the information processing device corresponding to the selected indicia according to the received selection data and the received duration data is then triggered.

In accordance with one example embodiment of the subject application, indicia, representative of a plurality of functionalities associated with an information processing device are generated on an associated touch screen display. Reference is made hereinafter to the document processing device 104 of FIG. 1 as a suitable information processing device, however the skilled artisan will appreciate that any suitable device equipped with a touch screen interface is capable of implementing the subject application. In addition, while reference is made herein to the touch screen as associated with the user interface 106 of the document processing device 104, the skilled artisan will appreciate that a touch screen interface independent of the user interface 106 of the document processing device 104 is also capable of being used herein, including, for example and without limitation, a kiosk (not shown) having a touch screen interface device proximate to, but not a part of, the document processing device 104 or other suitable information processing device.

Preferably, the indicia generated on the user interface 106 of the document processing device 104 correspond to graphical representations, such as widgets, icons, images, and the like, of functions, options, operations, and the like, associated with the document processing device 104. According to the subject example embodiment, a graphical user interface is generated by the controller 108, or other suitable component associated with the document processing device 104 on the user interface 106, inclusive of such functionality indicia. A touch down signal is then received from an associated user corresponding to a tactile exertion of positive physical pressure via the associated user interface 106; that is, the user presses one of the indicia on the touch screen of the user interface 106. The controller 108 or other suitable component associated with the document processing device 104 then receives duration data corresponding to the duration of the positive physical pressure. Stated another way, data corresponding to the length of time during which the user maintained touching of the indicia corresponding to a desired function, option, or the like, is received by the controller 108 or other suitable component associated with the document processing device 104. The function, option, operation, or the like associated with the indicia is then determined based upon the received touch down signal.

The controller 108 or other suitable component associated with the document processing device 104 then determines as to whether a predetermined duration has been exceeded. That is, a determination is made as to whether or not the user has maintained a positive physical exertion (touch down) for a pre-specified period of time, e.g., 1.5 seconds, 2 seconds, or the like. The skilled artisan will appreciate that such a pre-specified period of time differs from the quick touch down operation commonly used with graphical user interfaces. When the pre-selected or pre-specified period of time has not yet elapsed, a determination is made as to whether a touch up signal has been received; that is, whether the user has removed the physical exertion, e.g., stopped touching the indicia on the touch screen interface. When the user is merely selecting an icon, graphic, image, or other indicia for selection thereof and not for assistance therewith, the document processing device 104, e.g., the information processing device, performs the action, function, operation, or the like associated with the selected indicia.

When the duration, as determined by the received duration data, has exceeded the predetermined duration period, functionality associated with the selected indicia is retrieved from the data storage device 110 associated with the document processing device 104. In accordance with one embodiment of the subject application, following a determination that the duration of the physical contact made by the user with the indicia on the touch screen has exceeded a set time, help, assistance, and/or functionality data associated with the function, action, operation, or the like corresponding to the selected indicia is retrieved by the controller 108 or other suitable component from the associated data storage device 110. The retrieved functionality data is then displayed to the associated user via the touch screen of the user interface 106. Suitable functionality data includes, for example and without limitation, a brief description of the function, an example, an illustration, or the like, as will be appreciated by those skilled in the art.

The functionality data remains displayed to the user until a touch up signal is received (the user stops touching the indicia associated with the displayed functionality data). Following receipt of the touch up signal, the help, assistance, or functionality illustrated on the touch screen display of the user interface 106 is removed, and the system 100 waits for the next touch down signal from the user.

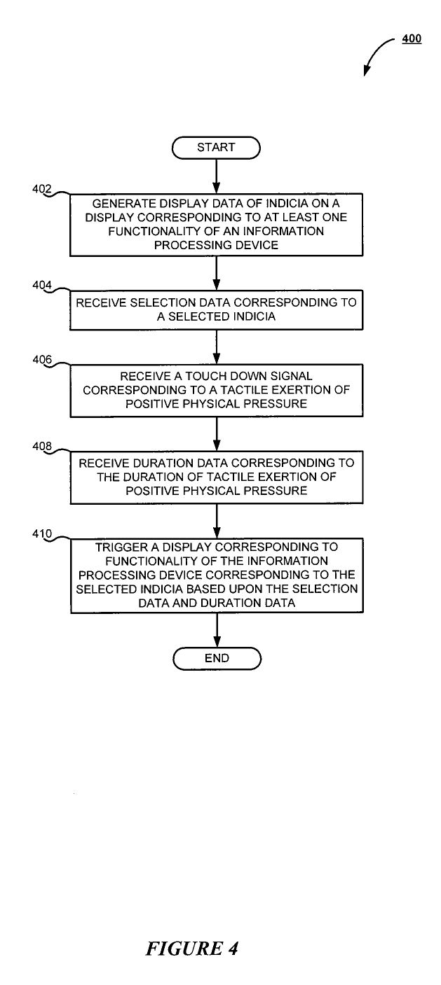

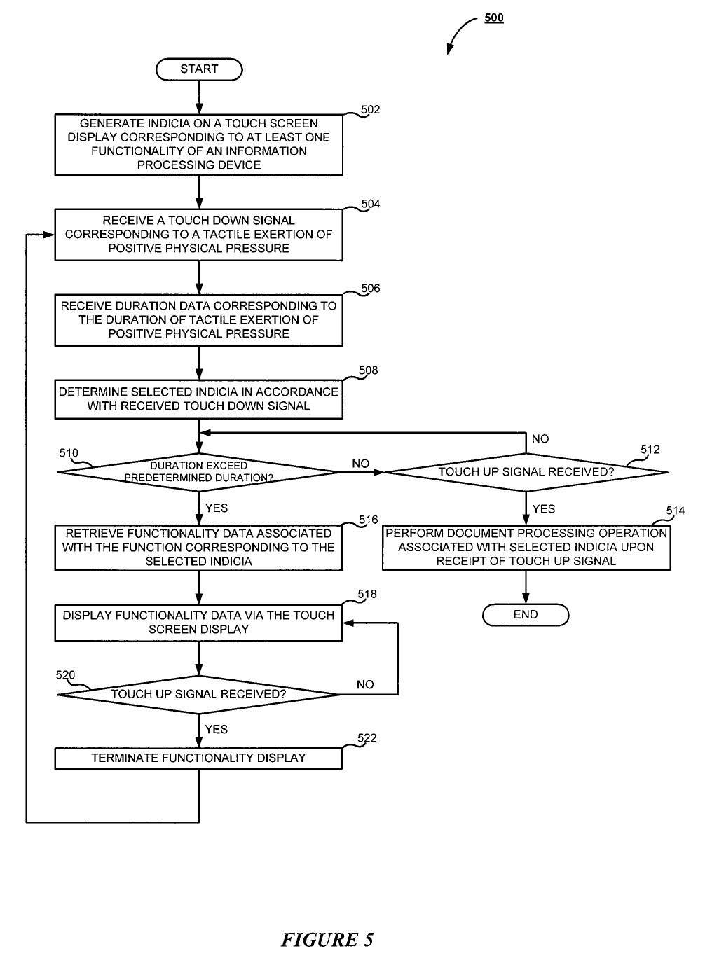

The skilled artisan will appreciate that the subject system 100 and components described above with respect to FIG. 1, FIG. 2, and FIG. 3 will be better understood in conjunction with the methodologies described hereinafter with respect to FIG. 4 and FIG. 5. Turning now to FIG. 4, there is shown a flowchart 400 illustrating a method for generating context sensitive help for a graphical user interface in accordance with one embodiment of the subject application. Beginning at step 402, display data corresponding to a plurality of indicia is first generated on an associated display, with each indicia, corresponding to a functionality of an associated information processing device. That is, a set of graphical images, or icons, are generated on the user interface 106 associated with the document processing device 104, with each icon representing a functionality capable of being performed by the document processing device 104, e.g., copy, scan, facsimile, image shift, edit, edge erase, time stamp, book center erase, xy zoom, image edit, e-file, settings, and the like. According to one embodiment of the subject application, the user interface 106 includes a touch screen interface, suitably adapted to display images to a user and receive input therefrom via tactile pressure exerted by the user.

Selection data is then received, for example, from an associated user, corresponding to one of indicia selected by the user from those displayed on the user interface 106 at step 404. At step 406, a touch down signal, corresponding to a tactile exertion of positive physical pressure by the associated user is received by the controller 108 or other suitable component associated with the document processing device 104 via the touch screen display of the user interface 106. Duration data is then received at step 408 representing the duration of the exerted positive physical pressure by the associated user. That is, the amount of time that the user maintains pressure on the touch screen display of the user interface 106 is received by the controller 108 as duration data. At step 410, a display of data associated with the functionality of the information processing device, e.g., the document processing device 104, is triggered corresponding to the selected indicia according to the received selection data and the received duration data.

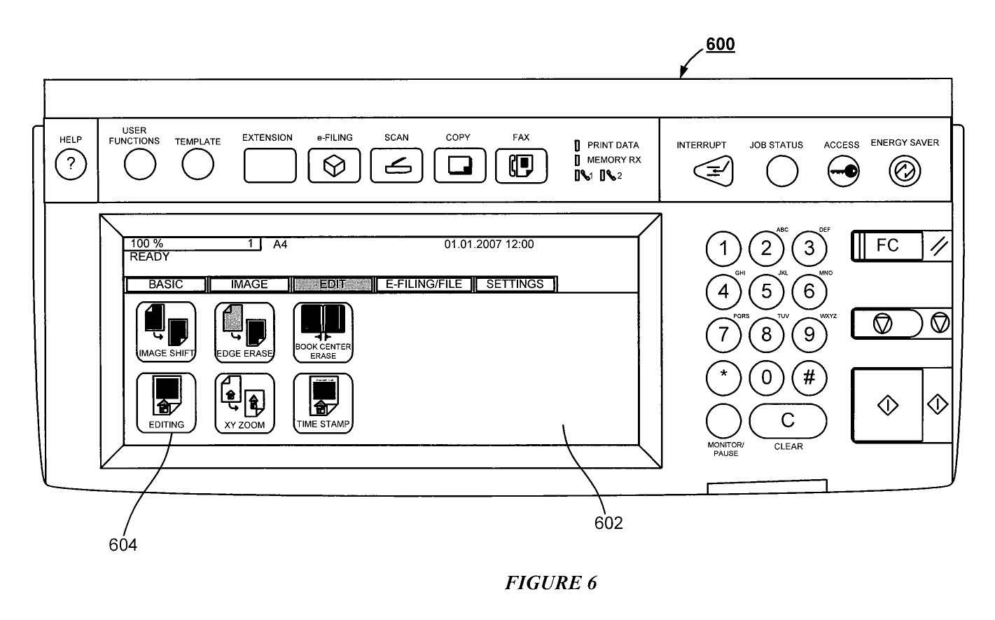

Referring now to FIG. 5, there is shown a flowchart 500 illustrating a method for generating context sensitive help for a graphical user interface in accordance with one embodiment of the subject application. The method depicted in FIG. 5 begins at step 502, whereupon indicia corresponding to functionalities associated with the document processing device 104 are generated on a touch screen display of the associated user interface 106. Preferably, the indicia generated on the user interface 106 of the document processing device 104 correspond to graphical representations, such as widgets, icons, images, and the like of functions, options, operations, and the like associated with the document processing device 104. According to the subject example embodiment, a graphical user interface is generated by the controller 108, or other suitable component associated with the document processing device 104 on the user interface 106, inclusive of such functionality indicia. A suitable example of a user interface 600 inclusive of the generated indicia is depicted in FIG. 6. As shown in FIG. 6, the user interface 600 includes a touch screen display 602 and a plurality of indicia 604 depicting functionality of the associated document processing device 104.

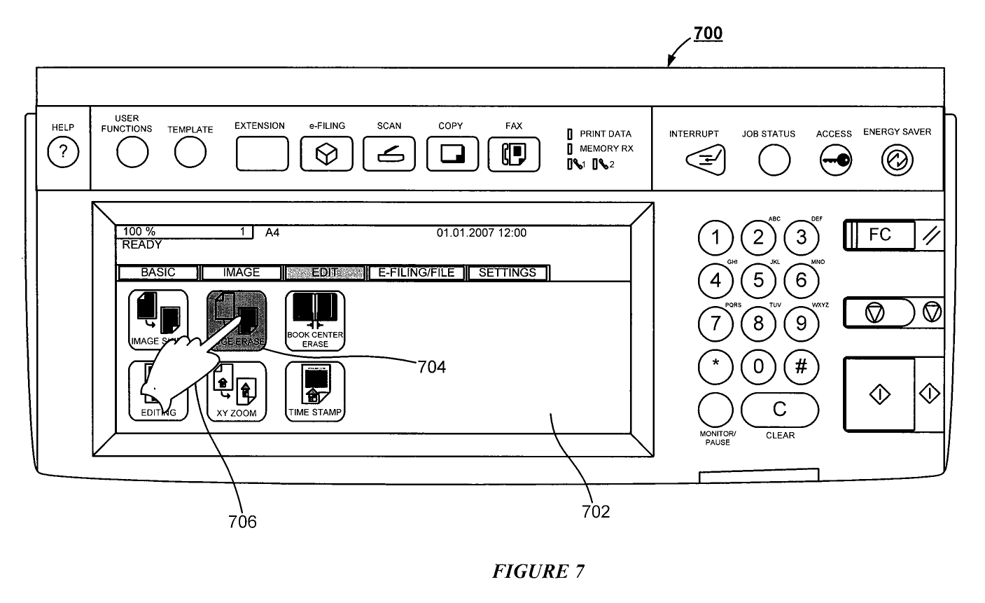

Returning to FIG. 5, at step 504, a touch signal is received from an associated user corresponding to a tactile exertion of positive physical pressure via the associated user interface 106. That is, the user presses one of the indicia on the touch screen of the user interface 106. A suitable example of such action is shown in FIG. 7. Referring now to FIG. 7, there is shown a user interface 700, inclusive of a touch screen display 702 and a plurality of indicia 704 corresponding to functionality associated with the document processing device 104. FIG. 7 further illustrates user interaction 706, representative of a user depressing one of the icons, or indicia 704, displayed on the touch screen 702.

From receipt of the touch signal at step 504, flow proceeds to step 506, whereupon duration data is received by the controller 108 or other suitable component associated with the document processing device 104 corresponding to the duration of the positive physical pressure. Stated another way, data corresponding to the length of time that user interaction 706 with the indicia 704 maintains contact with the indicia 704 is received by the controller 108 or other suitable component associated with the document processing device 104. At step 508, the controller 108 or other suitable component associated with the document processing device 104 and in data communication with the user interface 106 determines which of the displayed indicia the user has selected.

A determination is then made at step 510 as to whether a predetermined duration has been exceeded, e.g., whether the user has maintained a positive physical exertion (touch down) for a pre-specified period of time, e.g., 1.5 seconds, 2 seconds, or the like. The skilled artisan will appreciate that such a pre-specified period of time differs from the quick touch down operation commonly used with graphical user interfaces. Upon a negative determination at step 510, flow proceeds to step 512, whereupon a determination is made as to whether a touch up signal has been received; that is, the determination made at step 512 corresponds to whether the user has removed the physical exertion, e.g., stopped touching the indicia on the touch screen interface. When the user is merely selecting an icon, graphic, image, or other indicia for selection of the associated function, operation, or the like, and not for information corresponding thereto, flow proceeds to step 514, whereupon the document processing device 104, e.g., the information processing device, performs the action, function, operation, or the like associated with the selected indicia.

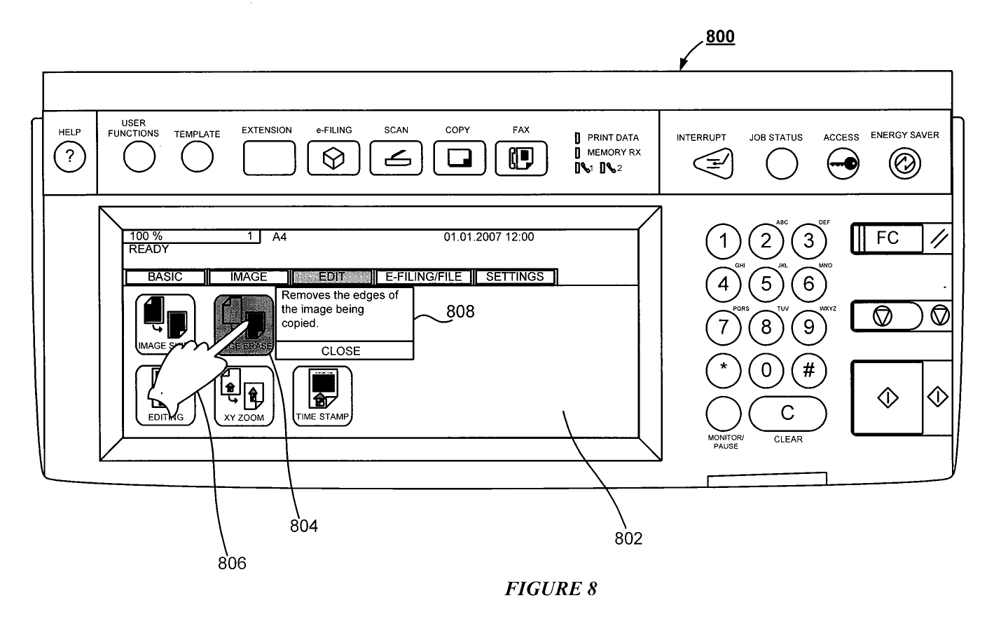

Upon a determination at step 510 that the duration of the touch down signal has exceeded the predetermined duration period, flow proceeds to step 516, whereupon the controller 108 or other suitable component associated with the document processing device 104 retrieves, from the associated data storage device 110, the functionality associated with the selected indicia. The retrieved functionality data is then displayed to the associated user via the touch screen of the user interface 106 at step 518. Suitable functionality data includes, for example and without limitation, a brief description of the function, an example, an illustration, or the like, as will be appreciated by those skilled in the art. A suitable example of such functionality is illustrated in FIG. 8, which depicts a user interface 800, inclusive of a touch screen display 802, and a plurality of indicia 804 corresponding to functionalities associated with the document processing device 104. Upon a determination that the user maintains pressure on a selected indicia for the predetermined period of time, e.g., the duration, as illustrated at 806, functional information is displayed to the user in the form of a brief description popup window 808. The skilled artisan will appreciate that the information retrieved and displayed to the user corresponds to the selected indicia, thereby providing the user with an easily readable and understood description of the function associated with the selected indicia. Thus, as illustrated in FIG. 8, the maintaining of constant physical pressure on the indicia corresponding to “edge erase” prompts the display of a brief description of what the “edge erase” function accomplishes.

Returning to FIG. 5, the functionality data displayed to the user at step 518 remains displayed until a determination is made at step 520 that a touch up signal has been received. That is, the data remains on the touch screen of the user interface 106 until such time as the user ceases pressing the corresponding indicia. When a touch up signal is received from the user, the functionality display is terminated at step 522, and operations return to step 504, whereupon a touch down signal is received from the user corresponding to a selected indicia displayed on the user interface 106.

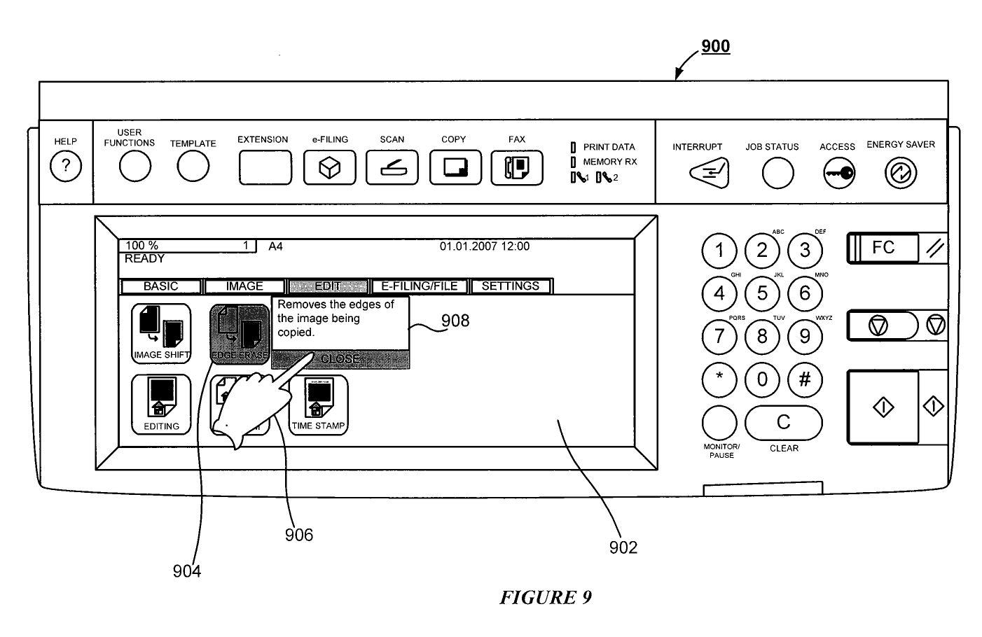

In accordance with an alternate embodiment of the subject application, the functionality data is capable of remaining displayed to the user until such time as the user selects to close the display. Such an example is depicted in FIG. 9, which includes a user interface 900 comprising a touch screen display 902, a plurality of functionality indicia 904, user interaction 906, and a popup window of functionality information 908. Thus, after the display of the functionality data, the user is able to remove the touch down signal, e.g., stop pressing the indicia, without the description being removed from the display. In such an embodiment, the user is required to terminate the display by the selection of an associated indicia displayed in the popup window 908, as will be understood by those skilled in the art. Thereafter, display on the user interface 900 returns to displaying just the indicia 904, as previously discussed with respect to FIG. 6 above.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A context sensitive help system for a graphical user interface comprising:
means adapted for generating display data corresponding to a display having a plurality of indicia, each indicia corresponding to at least one functionality of an associated information processing device;
means adapted for receiving selection data corresponding to a selected indicia from the plurality thereof;
means adapted for receiving a touch down signal corresponding to a tactile exertion of positive physical pressure;
means adapted for receiving duration data corresponding to a duration of tactile exertion of positive physical pressure; and
trigger means adapted for triggering a display of data corresponding to functionality of the associated information processing device corresponding to a selected indicia in accordance with received selection data and received duration data.

2. The system of claim 1 wherein the trigger means includes means adapted for triggering the display of data when the duration data exceeds a preselected duration of tactile exertion of positive physical pressure.

3. The system of claim 1 further comprising means adapted for terminating the display of data upon receipt of a touch up signal corresponding to removal of tactile exertion of positive physical pressure.

4. The system of claim 3 wherein the associated information processing device includes means adapted for performing at least one document processing operation in accordance with the selected indicia upon receipt of the touch up signal.

5. The system of claim 1 further comprising a touch screen display, the touch screen display including means adapted for generating a visual representation of each of the plurality of indicia and the means adapted for generating the touch down signal is from a sensed tactile exertion of positive physical pressure on a surface thereof corresponding to the selected indicia.

6. The system of claim 2 further comprising means adapted for generating a user feedback signal corresponding to receipt of a touch of a touch down signal.

7. A method for generating context sensitive help for a graphical user interface comprising the steps of:
generating display data of a plurality of indicia on an associated display, each indicia corresponding to at least one functionality of an associated information processing device;
receiving selection data corresponding to a selected indicia from the plurality thereof;
receiving a touch down signal corresponding to a tactile exertion of positive physical pressure;
receiving duration data corresponding to a duration of tactile exertion of positive physical pressure; and
triggering a display of data corresponding to functionality of the associated information processing device corresponding to a selected indicia in accordance with received selection data and received duration data.

8. The method of claim 7 wherein the display of data is triggered when the duration data exceeds a preselected duration of tactile exertion of positive physical pressure.

9. The method of claim 7 further comprising the step of terminating the display of data upon receipt of a touch up signal corresponding to removal of tactile exertion of positive physical pressure.

10. The method of claim 9 wherein the associated information processing device includes performs at least one document processing operation in accordance with the selected indicia upon receipt of the touch up signal.

11. The method of claim 7 wherein the step of generating display data of a plurality of indicia is on a touch screen display having a visual representation of each of the plurality of indicia and the step of generating a touch down signal from a sensed tactile exertion of positive physical pressure is via a surface thereof corresponding to the selected indicia.

12. The method of claim 8 further comprising the step of generating a user feedback signal corresponding to receipt of a touch of a touch down signal.

13. A computer-implemented method for generating context sensitive help for a graphical user interface comprising the steps of:
generating display data of a plurality of indicia on an associated display, each indicia corresponding to at least one functionality of an associated information processing device;
receiving selection data corresponding to a selected indicia from the plurality thereof;
receiving a touch down signal corresponding to a tactile exertion of positive physical pressure;
receiving duration data corresponding to a duration of tactile exertion of positive physical pressure; and
triggering a display of data corresponding to functionality of the associated information processing device corresponding to a selected indicia in accordance with received selection data and received duration data.

14. The computer-implemented method of claim 13 wherein the display of data is triggered when the duration data exceeds a preselected duration of tactile exertion of positive physical pressure.

15. The computer-implemented method of claim 13 further comprising the step of terminating the display of data upon receipt of a touch up signal corresponding to removal of tactile exertion of positive physical pressure.

16. The computer-implemented method of claim 15 wherein the associated information processing device includes performs at least one document processing operation in accordance with the selected indicia upon receipt of the touch up signal.

17. The computer-implemented method of claim 13 wherein the step of generating display data of a plurality of indicia is on a touch screen display having a visual representation of each of the plurality of indicia and the step of generating a touch down signal from a sensed tactile exertion of positive physical pressure is via a surface thereof corresponding to the selected indicia.

18. The computer-implemented method of claim 14 further comprising the step of generating a user feedback signal corresponding to receipt of a touch of a touch down signal.
